(19) United States
(12) Patent Application Publication
(10) Pub. No.: US 2017/0302747 A1
(43) Pub. Date: Oct. 19, 2017

(54) CARD-TYPE DESKTOP IMPLEMENTATION METHOD, APPARATUS, AND SYSTEM

(71) Applicant: ALIBABA GROUP HOLDING LIMITED, George Town (KY)

(72) Inventors: Zirong LUO, Hangzhou (CN); Xueshu QIAN, Hangzhou (CN); Yang YANG, Hangzhou (CN)

(73) Assignee: ALIBABA GROUP HOLDING LIMITED

(21) Appl. No.: 15/639,677

(22) Filed: Jun. 30, 2017

Related U.S. Application Data
(63) Continuation of application No. PCT/CN2015/098258, filed on Dec. 22, 2015.

(30) Foreign Application Priority Data
Dec. 31, 2014 (CN) CN201410848894.X

(51) Int. Cl. H04L 29/08; G06F 17/30; G06F 3/0481; G06F 17/22

(52) U.S. Cl. CPC H04L 67/16; H04L 67/06; H04L 67/02; G06F 3/0481; G06F 17/30091; G06F 17/30896; G06F 17/2247

(57) ABSTRACT

The present invention provides card-type desktop implementation methods, apparatuses and systems. Some embodiments comprise: a service management module sending a resource address of a service card from a server terminal to a desktop module; the desktop module creating a view area on a desktop, the view area being used to display the service card corresponding to the resource address, creating a view corresponding to the service card in the view area, and sending view information and the resource address to a rendering module; and the rendering module acquiring a resource file corresponding to the resource address from the server terminal, and rendering the resource file to the view according to the view information. The embodiments of the present invention can get rid of template restrictions, reduce system consumption, and improve stability of the desktop.

### CROSS-REFERENCE TO RELATED APPLICATIONS

This application claims priority to International Application No. PCT/CN2015/098258, filed on Dec. 22, 2015, which claims the priority to and the benefits of Chinese Application No. 201410848894.X, filed on Dec. 31, 2014, both of which are incorporated herein by reference in their entireties.

### TECHNICAL FIELD

The present invention relates to the field of computer application technologies, and in particular, to card-type desktop implementation methods, apparatuses and systems.

### BACKGROUND ART

With increasing popularization and development of mobile terminals, mobile terminals have not only been a tool for users to conduct communication, but also gradually become an important means of acquiring information. A great number of entities also send their own services to users through mobile terminals. At present, there are mainly the following two common manners:

The first manner is: a user installs an application installation package in a mobile terminal. An entity sends a service through a specific application, which then notifies an operating system to prompt related information in a taskbar or the like. The user clicks the related information to enter the specific application and view details.

The second manner is: an entity sends some simple text or link information through a short message or the like.

A problem existing in the first manner is that it is necessary to pre-install the corresponding application installation package. The user needs to go to the specific application when viewing the details. A problem existing in the second manner is that the structure of data pushed is relatively simple. User experience is relatively rough. The service is not friendly enough, and is basically one-time.

With respect to the above problems, a card-type desktop technique has been proposed. A desktop module displays data on a desktop in the form of a service card, so that the desktop will no longer only serve as a portal of applications. The user could directly see information that he/she wants to see on the desktop. In the current card-type desktop technology, the desktop module uses a certain desktop area as a display area of a card view, and defines a display template of the display area. A bottom layer service is connected to a server terminal, to acquire data to be displayed. The desktop module fills the data into the display template, to form a view displayed on the desktop.

However, such a manner has a relatively severe problem, which is: it is necessary to customize different templates for card services with different structures. Normal display is impossible if the mobile terminal has no corresponding templates. Therefore, card services with a number of structures require the mobile terminal to pre-set a nearly same number of templates, causing substantial system consumption.

### SUMMARY

In view of the above problems, the embodiments of the present invention provide card-type desktop implementation methods, apparatuses and systems, with which data display on a desktop can be free from template restrictions, thus reducing consumption.

Specific technical solutions are as follows:

Some embodiments of the present invention provide an exemplary card-type desktop implementation method including:

sending, by a service management module, a resource address of a service card from a server terminal to a desktop module;

creating, by the desktop module, a view area on a desktop, the view area being used to display the service card corresponding to the resource address; creating a view corresponding to the service card in the view area; and sending view information and the resource address to a rendering module; and

acquiring, by the rendering module, a resource file corresponding to the resource address from the server terminal; and rendering the resource file to the view according to the view information.

According to some embodiments of the present invention, the method further includes:

storing, by the desktop module, related information of the service card in a database, the related information of the service card including the resource address and the view information.

According to some embodiments of the present invention, the method further includes:

after startup of the desktop module and the rendering module, reading, by the desktop module, the related information of the service card in the database; creating a view on the desktop according to the view information; and sending the resource address and the view information to the rendering module; and

rendering, by the rendering module, the acquired resource file to the created view according to the view information, after acquiring the resource file corresponding to the resource address from the server terminal.

According to some embodiments of the present invention, the method further includes:

sending, by the service management module, a content update message to the desktop module, after receiving the content update message including the resource address;

sending, by the desktop module, the content update message to the rendering module; and

re-acquiring, by the rendering module, a resource file corresponding to the resource address from the server terminal, and re-rendering the acquired resource file to the corresponding view.

According to some embodiments of the present invention, the method further includes:

deleting, by the desktop module, a view corresponding to the service card when acquiring an event of deleting the service card by a user, a view area occupied by the view being restored to be available.

According to some embodiments of the present invention, the method further includes:

when the rendering module acquires an operational event of a user on the service card: responding, by the rendering module, to the operational event; or reporting the operational event to the desktop module, and responding, by the desktop module, to the operational event; or,

when a JavaScript code acquires an operational event of a user on the service card: reporting, by the JavaScript code, the operational event to the rendering module, and responding, by the rendering module, to the operational event; or reporting the operational event to the desktop module, and responding, by the desktop module, to the operational event.

According to some embodiments of the present invention, the responding, by the rendering module, to the operational event includes:

acquiring, by the rendering module from the server terminal, a resource file corresponding to a resource address requested by the operational event; and rendering the acquired resource file to the view corresponding to the service card; or,

reporting, by the rendering module, the operational event to the desktop module; creating, by the desktop module, a window on the desktop, and sending information of the window to the rendering module; acquiring, by the rendering module from the server terminal, a resource file corresponding to a resource address requested by the operational event; and rendering the acquired resource file to the created window according to the information of the window.

According to some embodiments of the present invention, the responding, by the desktop module, to the operational event includes:

sending, by the desktop module, a resource address requested by the operational event and view information corresponding to the service card to the rendering module; and rendering, by the rendering module, after acquiring from the server terminal a resource file corresponding to the resource address requested by the operational event, the acquired resource file to the corresponding view according to the view information; or,

creating, by the desktop module, a window on the desktop, and sending the resource address requested by the operational event and information of the created window to the rendering module; and rendering, by the rendering module after acquiring from the server terminal a resource file corresponding to the resource address requested by the operational event, the acquired resource file to the created window according to the information of the window.

According to some embodiments of the present invention, the created window can cover all or part of the view on the desktop, or the window may be in a fixed area of the desktop, the fixed area not conflicting with the view on the desktop.

According to some embodiments of the present invention, the JavaScript code, when reporting the operational event to the desktop module, further reports size and/or position information of the window to the desktop module; and

the desktop module performs, according to the size and/or the position information of the window, the step of creating a window on the desktop.

According to some embodiments of the present invention, the desktop module and the rendering module exchange information by means of inter-process communication.

According to some embodiments of the present invention, the rendering module calls a web engine to perform the operation of rendering.

The embodiments of the present invention further provide an exemplary card-type desktop apparatus including: a service management module, a desktop module, and a rendering module, wherein

the service management module is configured to: send a resource address of a service card from a server terminal to the desktop module;

the desktop module is configured to: create a view area on a desktop after receiving the resource address, the view area being used to display the service card corresponding to the resource address; create a view corresponding to the service card in the view area; and send view information and the resource address to the rendering module; and

the rendering module is configured to: after receiving the resource address and the view information sent by the desktop module, acquire a resource file corresponding to the resource address from the server terminal; and render the resource file to the view according to the view information.

According to some embodiments of the present invention, the desktop module is further configured to: store related information of the service card in a database, the related information of the service card including the resource address and the view information.

According to some embodiments of the present invention, the desktop module is further configured to: after startup of the desktop module and the rendering module, read the related information of the service card in the database; create a view on the desktop according to the view information; and send the resource address and the view information to the rendering module.

According to some embodiments of the present invention, the service management module is further configured to: send a content update message to the desktop module, after receiving the content update message including the resource address;

the desktop module is further configured to send the content update message to the rendering module; and

the rendering module is further configured to: re-acquire a resource file corresponding to the resource address from the server terminal; and re-render the acquired resource file to the corresponding view.

According to some embodiments of the present invention, the desktop module is further configured to: delete a view corresponding to the service card when acquiring an event of deleting the service card by a user, a view area occupied by the view being restored to be available.

According to some embodiments of the present invention, wherein,

the rendering module is further configured to: when acquiring an operational event of a user on the service card, respond to the operational event; or report the operational event to the desktop module and respond, by the desktop module, to the operational event; or,

the rendering module is further configured to: acquire an operational event reported by a JavaScript code on the service card, and respond to the operational event; or,

the desktop module is further configured to: acquire an operational event reported by a JavaScript code on the service card, and respond to the operational event.

According to some embodiments of the present invention, the rendering module, when responding to the operational event, is further configured to:

acquire from the server terminal a resource file corresponding to a resource address requested by the operational event; and render the acquired resource file to the view corresponding to the service card; or,

report the operational event to the desktop module; receive information of a window sent after the desktop module creates the window on the desktop; acquire, from the server terminal, a resource file corresponding to a resource address requested by the operational event; and render the acquired resource file to the created window according to the information of the window.

According to some embodiments of the present invention, the desktop module, when responding to the operational event, is further configured to: send a resource address requested by the operational event and view information corresponding to the service card to the rendering module; or,

the desktop module, when responding to the operational event, is further configured to: create a window on the desktop, and send the resource address requested by the operational event and information of the created window to the rendering module; and the rendering module is further configured to: render, after acquiring from the server terminal a resource file corresponding to the resource address requested by the operational event, the acquired resource file to the created window according to the information of the window.

According to some embodiments of the present invention, the window created by the desktop module can cover all or part of the view on the desktop. Alternatively, the desktop module can create a window in a fixed area of the desktop, the fixed area not conflicting with the view on the desktop.

According to some embodiments of the present invention, the desktop module is further configured to: receive size and/or position information of the window further reported when the JavaScript code reports the operational event; and perform, according to the size and/or the position information of the window, the operation of creating a window on the desktop.

According to some embodiments of the present invention, the desktop module and the rendering module exchange information by means of inter-process communication.

According to some embodiments of the present invention, the rendering module calls a web engine to perform the operation of rendering.

The embodiments of the present invention further provide exemplary systems for implementing a card-type desktop including: a management server and a mobile terminal, wherein,

the management server is configured to: acquire a resource address of a service card; and send the resource address of the service card to the mobile terminal; and

the mobile terminal including the apparatus described above.

According to some embodiments of the present invention, a provider server is further configured to send a content update message including the resource address to the management server; and

the management server is further configured to: send the content update message to the mobile terminal.

The embodiments of the present invention further provide an exemplary card-type desktop method including:

receiving a resource address of a service card from a server terminal;

creating a view area on a desktop, the view area being used to display the service card corresponding to the resource address, and creating a view corresponding to the service card in the view area; and

acquiring a resource file corresponding to the resource address from the server terminal, and rendering the resource file to the view according to the view information.

According to some embodiments of the present invention, the method further includes:

after a content update message including the resource address is received, re-acquiring a resource file corresponding to the resource address from the server terminal; and re-rendering the acquired resource file to the corresponding view.

According to some embodiments of the present invention, the method further includes:

deleting a view corresponding to the service card when an event of deleting the service card by a user is acquired, a view area occupied by the view being restored to be available.

According to some embodiments of the present invention, the method further includes:

acquiring an operational event of a user on the service card; and

after a resource file corresponding to a resource address requested by the operational event is acquired from the server terminal, rendering the acquired resource file to the corresponding view according to the view information; or creating a window on the desktop, and rendering the acquired resource file to the created window.

It is appreciated that, the above technical solutions provided by some embodiments of the present invention can implement loading and display of resource content in any format, by using a rendering module to render a resource file. Without relying on any template, the disclosed embodiments of the present disclosure thus reduce consumption brought about by storing templates.

### BRIEF DESCRIPTION OF DRAWING(S)

FIG. 1 is a structural diagram of an exemplary system architecture on which some embodiments of the present invention are based;

FIG. 2 is a diagram of an exemplary layout of a card-type desktop, according to some embodiments of the present invention;

FIG. 3 is a flow chart of an exemplary method, according to some embodiments of the present invention;

FIG. 4 is a flow chart of an exemplary process of creating a new card service, according to some embodiments of the present invention;

FIG. 5 is a flow chart of an exemplary process of establishing a card service when a mobile terminal is restarted, according to some embodiments of the present invention;

FIG. 6 is a flow chart of an exemplary process of updating content of a service card, according to some embodiments of the present invention;

FIG. 7 is a flow chart of an exemplary process of responding to an event of a user interacting with a service card, according to some embodiments of the present invention;

FIG. 8 is a flow chart of an exemplary process of responding to an event of a user interacting with a service card, according to some embodiments of the present invention;

FIG. 9 is a flow chart of an exemplary process of responding to an event of a user interacting with a service card, according to some embodiments of the present invention;

FIG. 10 is a diagram of an exemplary desktop card, according to some embodiments of the present invention;

FIG. 11 is an diagram of an exemplary desktop card after the desktop card shown in FIG. 10 is updated, according to some embodiments of the present invention;

FIG. 12 is a diagram of an exemplary desktop formed after the desktop card shown in FIG. 11 responds to an operational event of a user, according to some embodiments of the present invention; and

FIG. 13 is a diagram of an exemplary desktop formed after the desktop card shown in FIG. 11 responds to an operational event of a user, according to some embodiments of the present invention.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

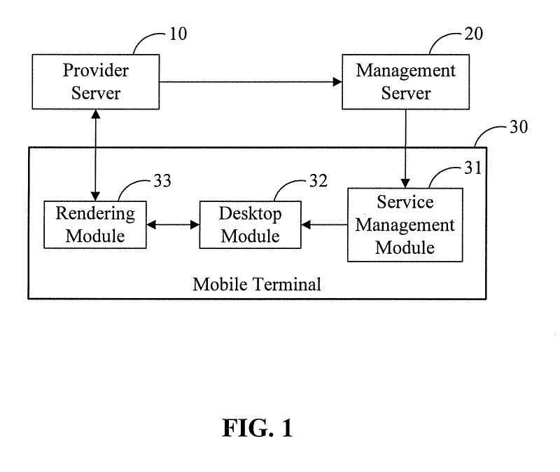

To facilitate understanding about embodiments of the present invention, FIG. 1 shows a structural diagram of an exemplary system architecture on which some embodiments of the present invention are based. As shown in FIG. 1, the system architecture can include a provider server 10, a management server 20, and a mobile terminal 30. The provider server 10 may also be independent of the system, that is, the system architecture may include a management server 20 and a mobile terminal 30.

Optionally, the mobile terminal 30 may include a card-type desktop implementation apparatus.

Optionally, the card-type desktop implementation apparatus may further include a service management module 31, a desktop module 32, and a rendering module 33. In general, the word “module,” as used herein, can be a packaged functional hardware unit designed for use with other components (e.g., portions of an integrated circuit) or a part of a program (stored on a computer readable medium) that performs a particular function of related functions. The module can have entry and exit points and can be written in a programming language, such as, for example, Java, Lua, C or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a computer readable medium, such as a compact disc, digital video disc, flash drive, magnetic disc, or any other non-transitory medium, or as a digital download (and can be originally stored in a compressed or installable format that requires installation, decompression, or decryption prior to execution). Such software code can be stored, partially or fully, on a memory device of the executing computing device, for execution by the computing device. Software instructions can be embedding in firmware, such as an EPROM. It will be further appreciated that hardware modules can be comprised of connected logic units, such as gates and flip-flops, and/or can be comprised of programmable units, such as programmable gate arrays or processors. The modules or computing device functionality described herein are preferably implemented as software modules, but can be represented in hardware or firmware. Generally, the modules described herein refer to logical modules that can be combined with other modules or divided into sub-modules despite their physical organization or storage.

A provider may wish to push resources to the mobile terminal, such as texts, videos, images, and the like. A resource address may be sent to the management server 20 through the provider server 10. The resource address may be a Uniform Resource Locator (URL), and is described as a URL in the subsequent embodiments, as an example. Here, the management server 20 may only open an interface to the provider server 10 with which it has a cooperation relation.

The management server 20 sends the URL to the service management module 31 in the mobile terminal 30. In some embodiments of the present invention, if a user of the mobile terminal 30 hopes to obtain a card service of a card-type desktop, the user may register at the management server 20 and subscribe to the card service in advance. The management server 20 may send a URL corresponding to the card service to the mobile terminal, which registers and subscribes to the card service. For example, a user may subscribe to a reading service of a provider. When the provider sends a URL, the management server 20 sends the URL to the service management module 31 in the mobile terminal 30 of the user.

The service management module 31 in the mobile terminal 30 sends the URL to the desktop module 32. The desktop module 32, after acquiring the URL, creates a view area on a desktop, the view area being used to display a service card corresponding to the URL. Here, the view area may be a view area not occupied on the desktop, and may also be a view area not occupied within a preset range on the desktop. Then, the desktop module 32 creates, in the view area, a view corresponding to the service card, and provides information of the view and the URL to the rendering module 33. The information of the view may be a handle of the view, that is, the desktop module 32 transmits the handle of the view to the rendering module 33.

The service management module 31 and the desktop module 32 may be implemented in the form of a process in the mobile terminal 30. That is, the service management module 31 and the desktop module 32 may be embodied as a service management process and a desktop process respectively.

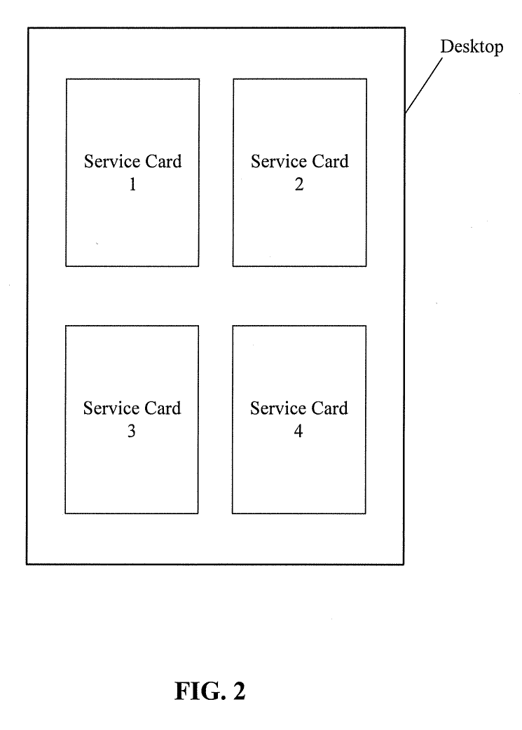

The view area may be created on the desktop according to a preset layout manner of a card-type desktop. For example, FIG. 2 is a diagram of an exemplary layout of a card-type desktop, according to some embodiments of the present invention. As shown in FIG. 2, the desktop module 32 may create the view area of the service card according to the layout manner shown in FIG. 2. If there is a view area not occupied, a resource file of the service card is rendered into a view in the view area, and in this example, there may be at most 4 service cards displayed on the desktop. It is appreciated that, FIG. 2 only shows an example of one layout, and the embodiments of the present invention do not limit the layout of the card-type desktop.

The rendering module 33 acquires a corresponding resource file according to the URL provided by the desktop module 32. That is, the rendering module 33 acquires, from the provider server 10, the resource file corresponding to the URL. The resource file may be a HyperText Mark-up Language (HTML) file, but may also be a multimedia file such as a video file or an image. Further, the multimedia file may also be embedded into the HTML file in actual implementation.

The rendering module 33, after obtaining the resource file, renders the resource file into the corresponding view, according to the information of the view provided by the desktop module 32. In this way, the resource file can be displayed in the view area, and may be embodied on the desktop as a service card resident on the desktop. In addition, the desktop module 32 may store related information of the service card in a database, such that the mobile terminal 30 can automatically read the related content and display the corresponding service card during startup. The related information of the service card may be URL information and information of the corresponding view. The information of the view may include a handle of the view, position information of the view, and the like. The rendering module 33 may be implemented by means of a web engine, that is, the rendering module 33 calls a web engine to perform the operation of rendering.

In some embodiments of the present invention, the rendering module 33 may enable a rendering process to render all service cards, and may also enable a plurality of rendering processes for rendering service cards respectively (in this case, the service cards and the rendering processes may be in a one-to-one relationship).

When the rendering module renders the HTML file, a main process thereof may include: parsing the HTML file, and converting an HTML document to a DOM tree, after which pattern parsing is performed, adding attributes such as color and size onto the DOM tree to form a render tree. A buffer may be utilized to draw each node of the render tree. Content drawn in the buffer is filled into the view corresponding to the service card. In some embodiments of the present invention, the desktop module 32 and the rendering module 33 can adopt a cross-process manner for processing the buffer. That is, the desktop module 32 may be responsible for managing the buffer, and the rendering module 33 may be responsible for utilizing the buffer to render the resource file.

When all the service cards share one rendering process, each service card corresponds to one buffer. The shared rendering process respectively utilizes the buffer corresponding to each service card to render the view corresponding to the service card. Such a manner can be applied to a situation where page complexity is relatively low, and may save the memory.

When each service card is respectively corresponding to one rendering process, all the service cards can share one buffer. The rendering module, after acquiring the resource file, utilizes the shared buffer and the corresponding rendering processes to render resource files. Such a manner can be applied to a situation where page complexity is high, and has relatively high processing capability.

After creation of the service card is completed, if the mobile terminal 30 is restarted, the desktop module 32 can read URL information and information of a view in the database. The desk module 32 can create the view on the desktop according to the information of the view; and provide the URL information and the information of the view to the rendering module 33. The rendering module 33 renders, after acquiring a resource file corresponding to the URL (e.g., requesting and acquiring the resource file corresponding to the URL from the provider server 10), the resource file to the corresponding view.

In some embodiments, a situation may exist where a provider needs to update content of the service card. The update may be periodic, and may also be occasional. The provider server 10 may send a content update message including a URL to the management server 20. The management server 20 sends the content update message to the service management module 31 of the mobile terminal 30. The service management module 31 sends the content update message to the desktop module 32. The desktop module 32 sends the content update message to the rendering module 33. The rendering module 33 may re-acquire a resource file corresponding to the URL, and re-render the resource file to the corresponding view.

As described above, the service card may be resident on the desktop, unless the user deletes the service card manually. That is, the desktop module 32 can delete a view corresponding to the service card when acquiring an event of deleting the service card by the user. A view area occupied by the view may be restored to be available, that is, not occupied.

In some embodiments, the service card can be resident on the desktop, and the user can interact with the service card through a user interface. When the user performs an operation on the service card, the rendering module 33 or a JavaScript code on the service card may capture the operation on the service card, and directly respond to the operation. Alternatively, the rendering module 33 or the JavaScript code may report the operation to the desktop module 32, and the desktop module 32 responds to the operation.

Under most circumstances, the interaction of the user with the service card through the user interface is a request for a new resource file. For example, the user can, by clicking a link in the resource file on the service card, request a resource file corresponding to the link. For another example, the view corresponding to the service card, due to a limited display area, may only display some contents of a whole page. For other contents, it is necessary for the user to slide or click a button of “display the remaining page content,” or slide a slider to request for the remaining resource files not displayed. No matter which manner is employed, after the user triggers an event of requesting a new resource file, the JavaScript code of the service card or the rendering module 33 captures the event. If the JavaScript code captures the event, the rendering module 33 or the desktop module 32 may be notified.

When the rendering module 33 acquires the event triggered by the user, if the event is within the response permission of the rendering module 33, the rendering module 33 can directly acquire, from the provider server 10, a resource file corresponding to a resource address requested by the event. The rendering module may then render the acquired resource file to the corresponding view.

When the rendering module 33 acquires the event triggered by the user, if the event is beyond the response permission of the rendering module 33, the event may be reported to the desktop module 32. The desktop module 32 provides a resource address requested by the event and information of the corresponding view to the rendering module 33. The rendering module 33, after acquiring the resource file from the provider server 10, renders the new resource file to the corresponding view. In addition, in this example, the desktop module 32 may also create a window, and provide resource address information requested by the event and corresponding window information to the rendering module 33. The rendering module 33 can acquire from the server terminal a resource file corresponding to the address requested by the event, and render the acquired resource file to the created window.

If the JavaScript code captures an the operational event, the JavaScript code then notifies the desktop module 32 of the captured event. The desktop module 32 may send the address requested by the event and the information of the view to the rendering module 33. The rendering module 33, after acquiring from the server terminal a resource file corresponding to the address requested by the event, renders the acquired resource file to the corresponding view. Alternatively, the desktop module 32 may create a window, and send the address requested by the event and information of the created window to the rendering module 33. The rendering module 33, after acquiring from the server terminal a resource file corresponding to the address requested by the event, renders the acquired resource file to the created window.

The desktop module 32, when creating a window, may adopt various manners. For example, the desktop module 32 may create a large window, and the window may cover all or part of the view on the card-type desktop. For another example, the window may be in a fixed area of the desktop, and the fixed area may not conflict with the view on the card-type desktop.

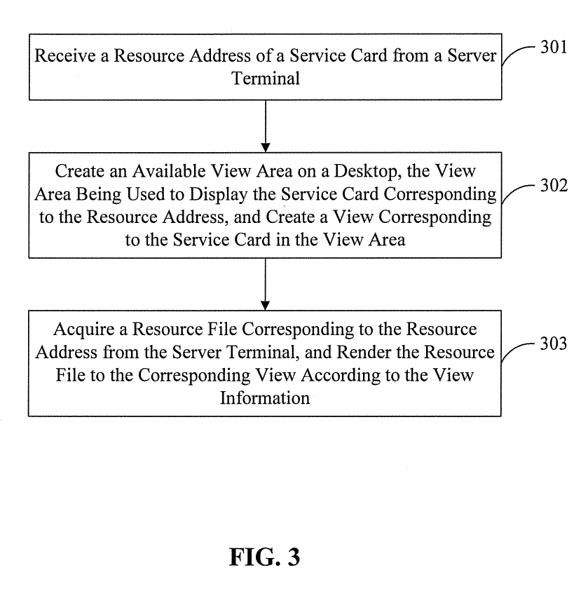

FIG. 3 is a flow chart of an exemplary method, according to some embodiments of the present invention. For the mobile terminal, a process of creating a new card service according to embodiments associated with FIG. 3 may be performed, the process may further comprise the following steps:

In 301, receiving, from a server terminal, a resource address of a service card.

In 302, creating a view area on a desktop, the view area being used to display the service card corresponding to the resource address. A view corresponding to the service card is created in the view area.

In 303, acquiring a resource file corresponding to the resource address from the server terminal, and rendering the resource file to the view according to the view information.

Further, if a content update message including the resource address is received, a resource file corresponding to the resource address may be re-acquired from the server terminal. The acquired resource file may then be re-rendered to the corresponding view.

When an event of deleting the service card by a user is acquired, a view corresponding to the service card is deleted. A view area occupied by the view is restored to be available.

When an operational event of a user on the service card is acquired, after a resource file corresponding to a resource address requested by the operational event is acquired from the server terminal, the acquired resource file is rendered to the corresponding view according to the view information. Alternatively, a window can be created on the desktop, and the acquired resource file can be rendered to the created window.

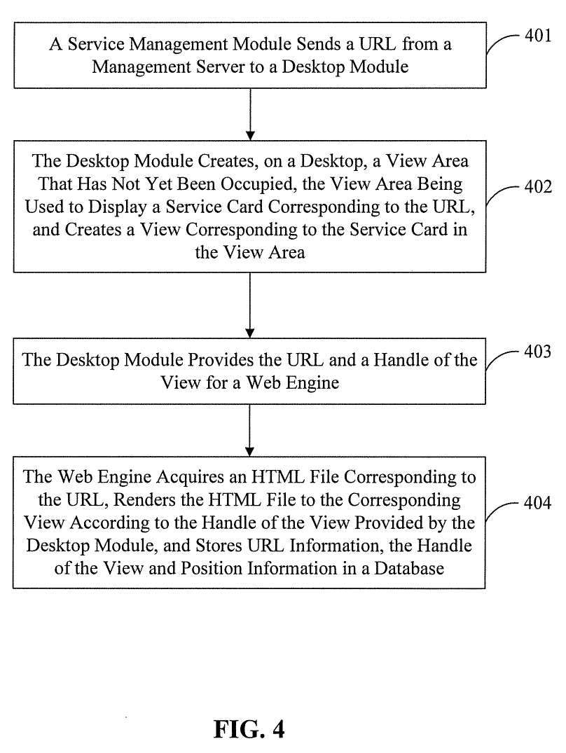

When the system architecture shown in FIG. 1 is employed to implement the process of creating a new card service, the process thereof may be as shown in FIG. 4. In the example shown in FIG. 4, the service management module and the desktop module are implemented by means of processes. The rendering module is implemented by means of a web engine. The following steps can be further included in this example:

In step 401, a service management module sends a URL from a management server to a desktop module.

In step 402, the desktop module creates, on a desktop, a view area that has not yet been occupied, the view area being used to display a service card corresponding to the URL. A view corresponding to the service card is created in the view area.

In step 403, the desktop module provides the URL and a handle of the view to the web engine.

In step 404, the web engine acquires an HTML file corresponding to the URL; renders the HTML file to the corresponding view according to the handle of the view provided by the desktop module; and stores the URL information, and the handle and position information of the view in a database.

In addition, the web engine may also return state information in the rendering process to the desktop module.

Further, in the above example process, the service management module, the desktop module, and the web engine may exchange information in a manner of inter-process communication. The manner of inter-process communication may include, but is not limited to, a broadcast manner, a file mapping manner, a memory sharing manner, a dynamic link library sharing manner, and the like. That is: the service management module can send the URL to the desktop module by means of inter-process communication; the desktop module can provide the URL and the handle of the view to the web engine by means of inter-process communication; and the web engine can return rendering state information by means of inter-process communication.

It is appreciated that, the above embodiments of the present invention, by means of rendering, no longer rely on any template, and can implement loading and display of resource content in any form. It no longer needs to store multiple templates, thus reducing consumption. In addition, in some embodiments, acquisition and rendering of a resource file is no longer performed by the desktop module, but is performed by another process, for example, the web engine. Rendering of the service card would not affect the desktop module, nor bring about burden to the desktop module, thereby reducing consumption and improving stability.

In addition, the mobile terminal does not need to be installed with any specific application. A resource file pushed by the provider server can be directly seen on the desktop, thus saving operational costs of the user and enhancing user experience.

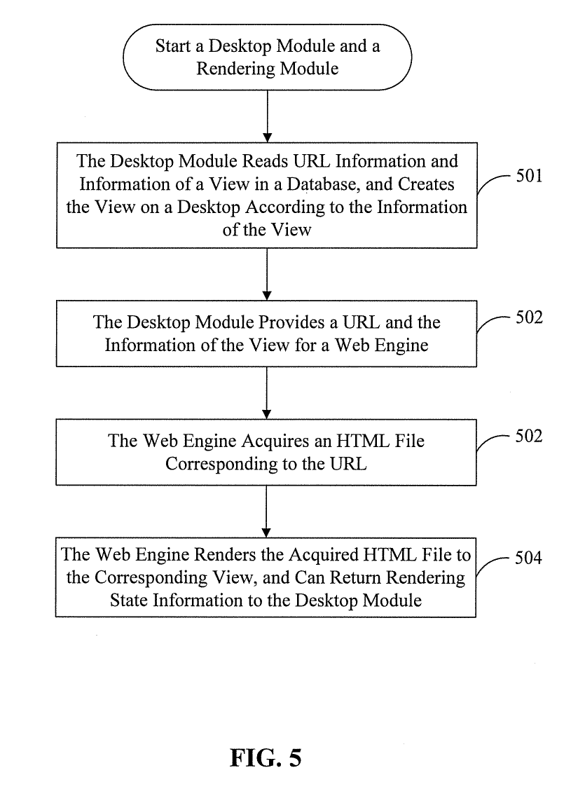

If the mobile terminal is restarted, the mobile terminal may be started according to the exemplary process as shown in FIG. 5, which may further include the following steps:

In step 501, after startup of the desktop module and the rendering module, the desktop module reads the URL information and the information of the view in the database, and creates a view on the desktop according to the information of the view.

The information of the view may include the handle of the view and position information of the view. According to the position information of the view and the preset layout manner of the card-type desktop, the desktop module creates a view area, and creates a View in the view area.

In step 502, the desktop module provides the URL and the information of the view to the web engine.

In step 503, the web engine acquires an HTML file corresponding to the URL. For example, the web engine requests and acquires a resource file corresponding to the URL from the provider server.

In step 504, the web engine renders the acquired HTML file to the corresponding view, and can return rendering state information to the desktop module.

Through the above exemplary process, when the mobile terminal starts, the card-type desktop may be displayed automatically. The user can directly see a subscribed service card on the desktop.

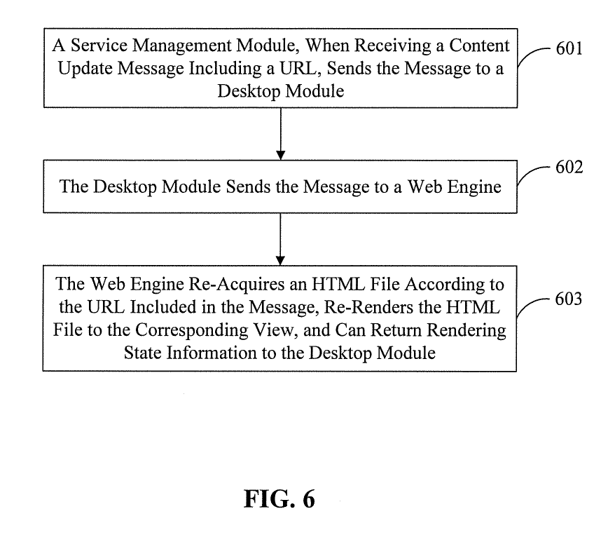

When the provider needs to update content of the service card, the mobile terminal may perform an update process, for example, the exemplary update process as shown in FIG. 6. As shown in FIG. 6, the process may further includes the following steps:

In step 601, a service management module, when receiving a content update message including a URL, sends the message to a desktop module.

In step 602, the desktop module sends the message to a web engine.

In step 603, the web engine re-acquires an HTML file according to the URL included in the message, re-renders the HTML file to the corresponding view, and can return rendering state information to the desktop module.

It is appreciated that, when a resource file needs to be updated, it may be only necessary to send a content update message according to the process shown in FIG. 6, without consumption caused by too many long connections and polling.

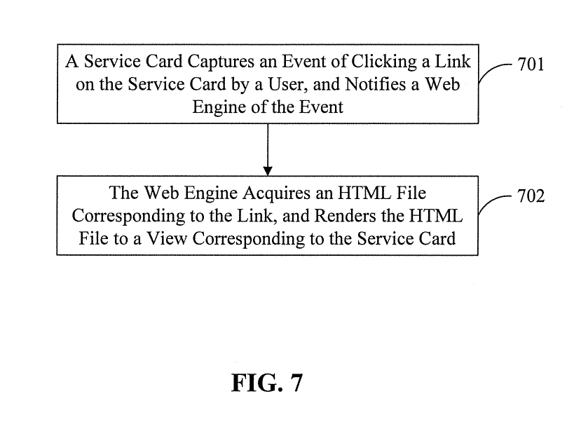

When the user interacts with the service card through the user interface provided by the service card, the mobile terminal may perform the exemplary process as shown in FIG. 7. In this example, that the user clicks a link on the service card and the web engine has response permission is taken as an example. The following steps are included:

In step 701, a service card (e.g., a JavaScript code of the service card) captures an event of clicking a link on the service card by the user, and notifies the web engine of the event.

In some embodiments, it is also possible that an event processing module in the web engine directly captures an event of clicking a link on the service card by the user.

In step 702, the web engine acquires, from the provider server, an HTML file corresponding to the link, and renders the HTML file to a view corresponding to the service card.

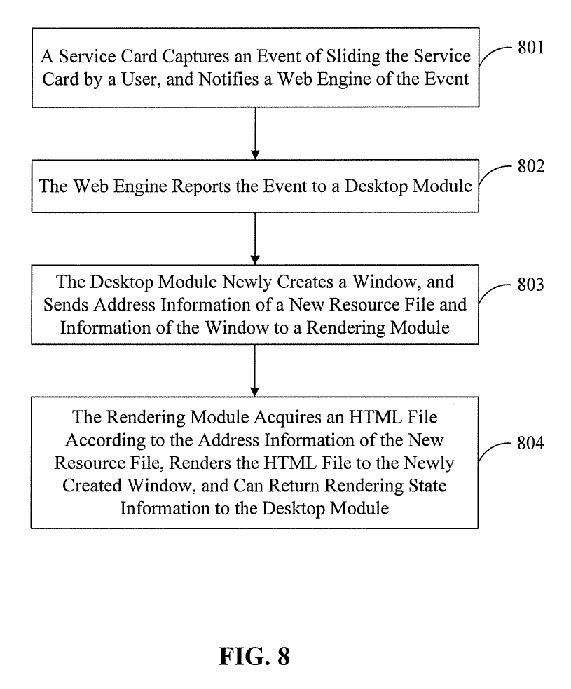

When the user interacts with the service card through the user interface provided by the service card, the mobile terminal may also perform the exemplary process as shown in FIG. 8. In this example, that the user slides the service card and the web engine does not have response permission is taken as an example. The following steps are included:

In step 801, a service card (e.g., a JavaScript code of the service card) captures an event of sliding the service card by the user, and notifies the web engine of the event.

In some embodiments, it is also possible that an event processing module in the web engine directly captures an event of sliding the service card by the user.

In step 802, the web engine reports the event to the desktop module.

In some embodiments, it is also possible that the JavaScript code of the service card directly reports the event to the desktop module.

In step 803, the desktop module creates a window, and sends address information of a new resource file and information of the window to a rendering module.

In step 804, the rendering module acquires an HTML file according to the address information of the new resource file, renders the HTML file to the created window, and can return rendering state information to the desktop module.

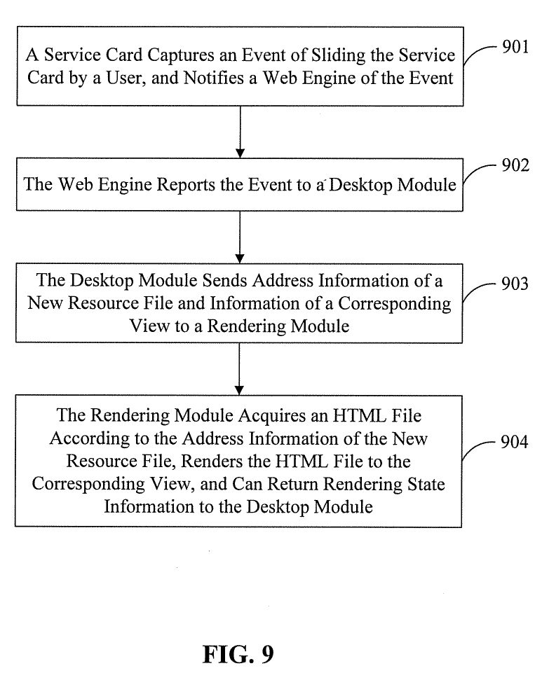

When the user interacts with the service card through the user interface provided by the service card, the mobile terminal may also perform the exemplary process as shown in FIG. 9. In this example, that the user slides the service card and the web engine does not have response permission is taken as an example. The following steps are included:

In step 901, a service card (e.g., a JavaScript code of the service card) captures an event of sliding the service card by the user, and notifies the web engine of the event.

In some embodiments, it is also possible that an event processing module in the web engine directly captures an event of sliding the service card by the user.

In step 902, the web engine reports the event to the desktop module.

In some embodiments, it is also possible that the JavaScript code of the service card directly reports the event to the desktop module.

In step 903, the desktop module sends address information of a new resource file and information of the corresponding view to a rendering module.

In step 904, the rendering module acquires an HTML file according to the address information of the new resource file, renders the HTML file to the corresponding view. The rendering module can also return rendering state information to the desktop module.

The embodiments associated with FIG. 9 are different from the embodiments associated with FIG. 8 in that, after the user clicks a link, a resource file corresponding to the link is still displayed in the original view. In contrast, the embodiments associated with FIG. 8 display the resource file through a new window.

Further, in some embodiments associated with FIG. 8, the desktop module may create a window according to a preset window size and window position information.

In addition, in some embodiments associated with FIG. 8, if the JavaScript code directly reports the event to the desktop module, the JavaScript code, when reporting the event, may further report the window size and/or the position information to the desktop module. The desktop module may create a window according to the received window size and/or position information. In some embodiments, the JavaScript code may determine a window size and/or position suitable for displaying the HTML file according to at least one piece of the information such as the size of the HTML file corresponding to the link, and the size and resolution of the screen of the mobile terminal. How the window size and/or position are/is specifically determined is not limited in the embodiments of the present invention.

It can be seen from the embodiments associated with FIG. 7 to FIG. 9 that the user, may interact with the service card through the user interface provided by the service card on the card-type desktop. For example, the user may acquire more service contents, thereby further improving user experience. In addition, a variety of implementations such as displaying in the original view and displaying in a created window are further provided, and the implementations are flexible and rich.

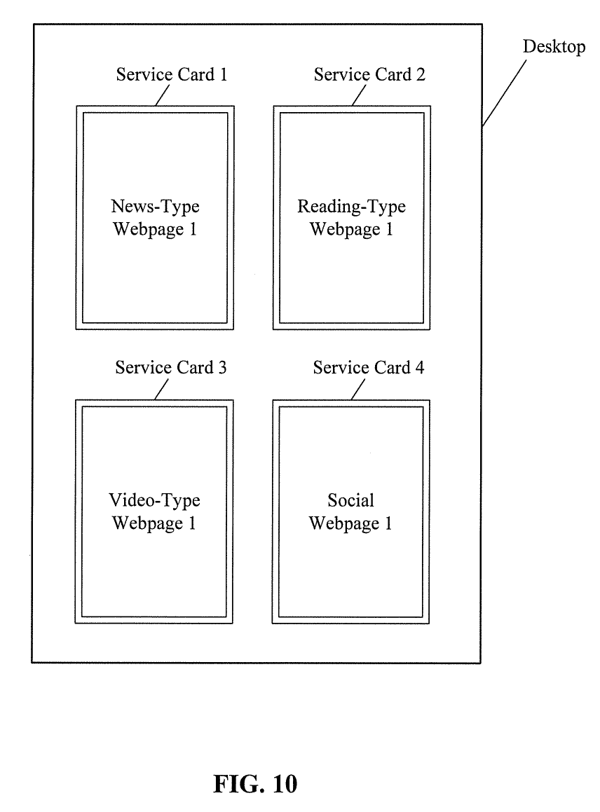

As an example of the effect, if a user subscribes to a news-type service card, a reading-type service card, a video-type service card, and a social service card, through the exemplary process shown in FIG. 4, the desktop card as shown in FIG. 10 may be implemented on the desktop. In this example, the desktop card further includes four service cards, and the four service cards are respectively “news-type webpage 1,” “reading-type webpage 1,” “video-type webpage 1,” and “social webpage 1,” provided by a provider.

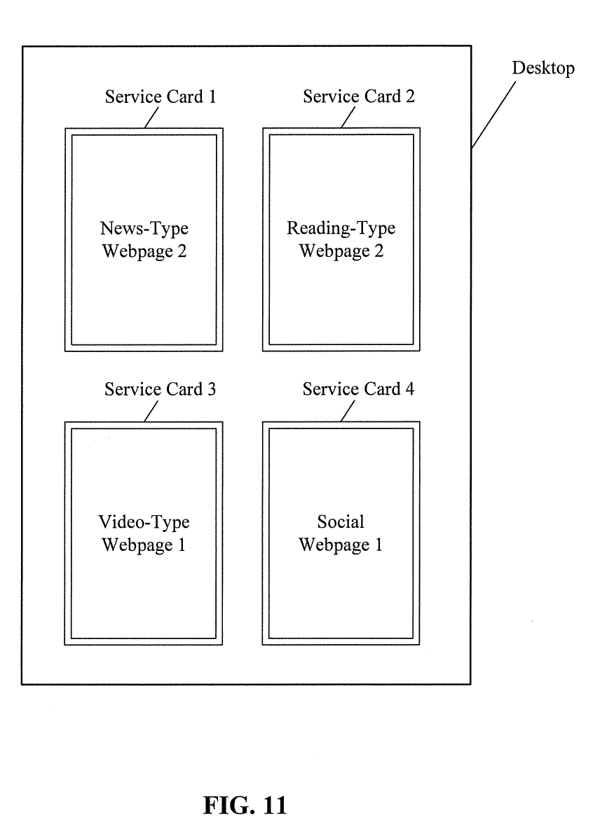

Each service card can update content of the service card according to the exemplary process shown in FIG. 6. Suppose that the news-type service card in FIG. 10 would update the content of the service card every two hours, the updated service card can form a card-type desktop as shown in FIG. 11. In this example, the content of the news-type service card becomes a “news-type webpage 2.”

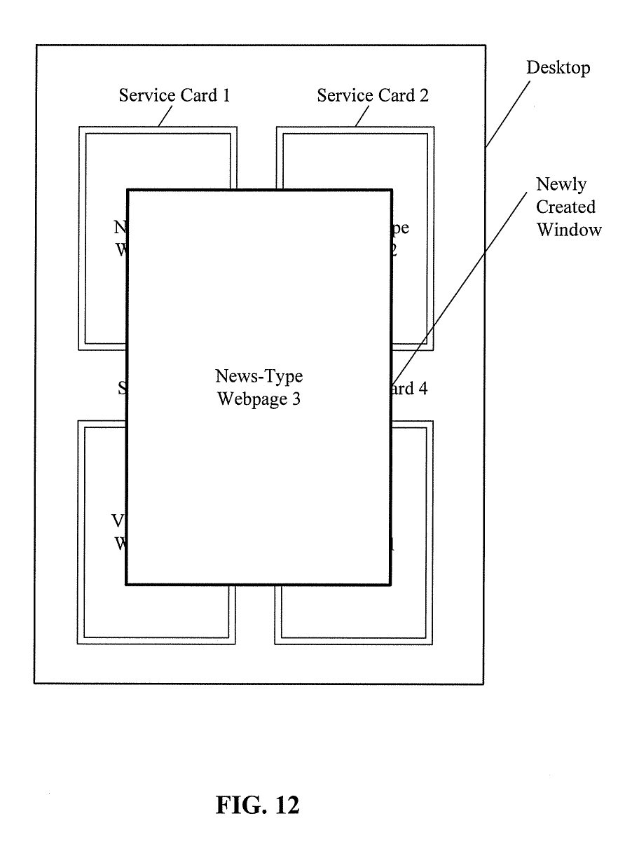

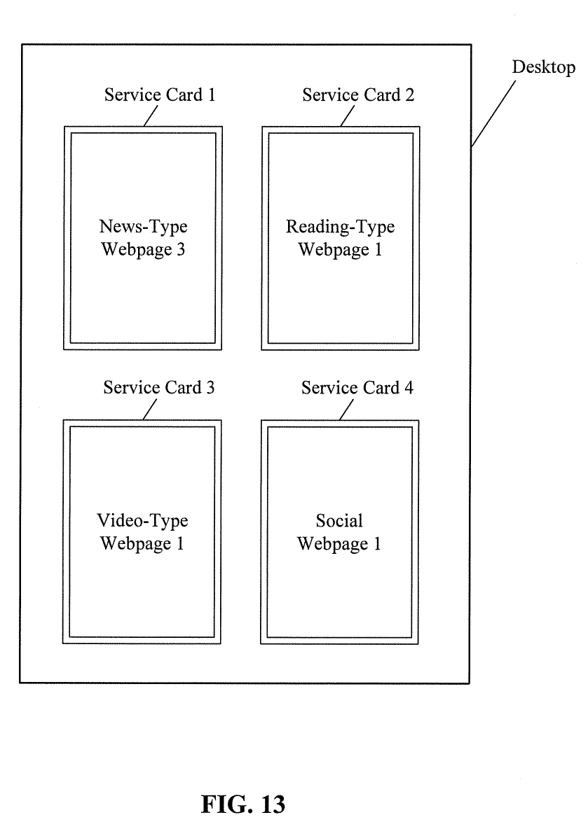

On the card-type desktop shown in FIG. 11, suppose that the user clicks a link of a piece of specific news in the “news-type webpage 2”, execution may be performed according to the exemplary process shown in FIG. 8. A “news-type webpage 3” corresponding to the link may be displayed in a created window, for example, as shown in FIG. 12. Execution may also be performed according to the exemplary process shown in FIG. 7 or FIG. 9, to display a “news-type webpage 3” corresponding to the link in the original view, as shown in FIG. 13.

In the several embodiments provided in the present invention, it should be appreciated that the disclosed systems, apparatuses and methods may be implemented in other manners. For example, the described apparatus embodiments are only exemplary. Further, division of the units is merely division of logical functions and division in other manners may exist in actual implementation.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware plus a software functional unit.

The integrated unit implemented in the form of a software functional unit may be stored in a computer-readable storage medium. The software functional unit can be stored in a storage medium, which includes a set of instructions for instructing a computer device (which may be a personal computer, a server, a network device, or the like) or a processor to perform a part of the steps of the methods described in the embodiments of the present invention. The foregoing storage medium may include, for example, any medium that can store a program code, such as a USB flash disk, a removable hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The foregoing are merely some embodiments of the present invention, which are not used to limit the present invention. Any modification, equivalent replacement, improvement, and the like made within the spirit and principle of the present invention shall all be included in the protection scope of the present invention.

1. A card-type desktop implementation method, comprising:
acquiring a resource address of a service card from a server terminal;
creating, by a desktop module, a view area on a desktop, the view area being used to display the service card corresponding to the resource address;
creating, by the desktop module, a view corresponding to the service card in the view area;
acquiring, by a rendering module, a resource file corresponding to the resource address from the server terminal; and
rendering, by the rendering module, the resource file to the view according to view information.

2. The method according to claim 1, further comprising:
storing, related information of the service card in a database, the related information of the service card comprising the resource address and the view information.

3. The method according to claim 2, further comprising:
reading, the related information of the service card in the database.

4. The method according to claim 1, further comprising:
receiving a content update message comprising the resource address; and
re-acquiring, by the rendering module, a resource file corresponding to the resource address from the server terminal.

5. The method according to claim 1, further comprising:
acquiring an event of deleting the service card by a user; and
deleting the view corresponding to the service card,
wherein a view area occupied by the view is restored to be available.

6. The method according to claim 1, further comprising:
acquiring an operational event of a user on the service card; and
responding, to the operational event,
wherein the operational event is captured by one of a JavaScript code on the service card and the rendering module.

7. The method according to claim 6, wherein responding to the operational event is performed by the rendering module, the method further comprising:
acquiring, from the server terminal, a second resource file corresponding to a resource address requested by the operational event; and
rendering the second resource file to either the view corresponding to the service card, or to a created window on the desktop created by the desktop module.

8. The method according to claim 6, wherein responding to the operational event is performed by the desktop module, the method further comprising:
sending, by the desktop module, a resource address requested by the operational event and the view information corresponding to the service card to the rendering module; and
rendering a second resource file to the corresponding view, wherein the second resource file corresponds with the resource address requested by the operational event.

9. The method according to claim 7, wherein the created window covers either at least a part of the view, or an area not conflicting with the view on the desktop.

10. (canceled)

11. The method according to claim 1, wherein the desktop module and the rendering module exchange information by means of inter-process communication.

12. The method according to claim 1, wherein the rendering module calls a web engine to perform the operation of rendering.

13. A card-type desktop implementation apparatus, comprising:
a desktop module configured to:
create a view area on a desktop after receiving a resource address of a service card, the view area being used to display the service card corresponding to the resource address; and
create a view corresponding to the service card in the view area; and
a rendering module, configured to:
acquire a resource file corresponding to the resource address from a server terminal; and
render the resource file to the view according to view information.

14. The apparatus according to claim 13, wherein the desktop module is further configured to:
store related information of the service card in a database, the related information of the service card comprising the resource address and the view information.

15. The apparatus according to claim 14, wherein the desktop module is further configured to:
read the related information of the service card in the database.

16. The apparatus according to claim 13, wherein
the desktop module is further configured to, send an content update message comprising the resource address to the rendering module; and
the rendering module is further configured to, re-acquire a resource file corresponding to the resource address from the server terminal.

17. The apparatus according to claim 13, wherein the desktop module is further configured to:
acquire an event of deleting the service card by a user; and
delete the view corresponding to the service card
wherein a view area occupied by the view is restored to be available.

18. The apparatus according to claim 13, wherein
at least one of the rendering module and the desktop module is further configured to,
acquire an operational event of a user on the service card; and
respond to the operational event,
wherein the operational event is captured by one of a JavaScript code on the service card and the rendering module.

19. The apparatus according to claim 18, wherein
the rendering module, when responding to the operational event, is further configured to:
acquire, from the server terminal, a second resource file corresponding to a resource address requested by the operational event; and
render the second resource file to either the view corresponding to the service card, or to a created window on the desktop.

20. The apparatus according to claim 18, wherein
the desktop module, when responding to the operational event, is further configured to:
send a resource address requested by the operational event and the view information corresponding to the service card to the rendering module; or,
create a window on the desktop, and send the resource address requested by the operational event and information of the created window to the rendering module, wherein the rendering module renders a second resource file to the created window, the second resource file corresponding to the resource address requested by the operational event.

21. The apparatus according to claim 19, wherein the window created by the desktop module covers either at least a part of the view, or an area not conflicting with the view on the desktop.

22. The apparatus according to claim 20, wherein the desktop module is further configured to:
receive, the operational event and at least one of size and position information of the window, from the JavaScript code; and
create the window according to the at least one of size and the position information of the window.

23. The apparatus according to claim 13, wherein the desktop module and the rendering module exchange information by means of inter-process communication.

24. The apparatus according to claim 13, wherein the rendering module calls a web engine to perform the operation of rendering.

25. (canceled)

26. (canceled)

27. A card-type desktop implementation method, comprising:
receiving a resource address of a service card from a server terminal;
creating a view area on a desktop, the view area being used to display the service card corresponding to the resource address;
creating a view corresponding to the service card in the view area;
acquiring a resource file corresponding to the resource address from the server terminal; and
rendering the resource file to the view according to view information.

28. The method according to claim 27, further comprising:
receiving a content update message comprising the resource address; and
re-acquiring a resource file corresponding to the resource address from the server terminal.

29. The method according to claim 27, further comprising:
acquiring an event of deleting the service card by a user; and
deleting the view corresponding to the service card,
wherein a view area occupied by the view is restored to be available.

30. The method according to claim 27, further comprising:
acquiring an operational event of a user on the service card;
acquiring, from the server terminal, a second resource file corresponding to a resource address requested by the operational event; and
rendering the second resource file to either the view, or a created window on the desktop.

31. The method according to claim 6, wherein responding to the operational event is performed by the desktop module, the method further comprising:
sending, by the desktop module, a resource address requested by the operational event and the view information corresponding to the service card to the rendering module;
creating, by the desktop module, a window on the desktop;
sending the resource address requested by the operational event and information of the created window to the rendering module; and
rendering the second resource file to the created window.

32. The method according to claim 31, further comprising:
reporting, the operational event and at least one of size and position information of the window to the desktop module; and
creating, by the desktop module, the window based on the at least one of size and position information of the window.

33. The method according to claim 31, wherein the created window covers either at least a part of the view, or an area not conflicting with the view on the desktop.

34. The method according to claim 30, wherein the created window covers either at least a part of the view, or an area not conflicting with the view on the desktop.

35. A non-transitory computer readable medium that stores a set of instructions that are executable by at least one processor of a card-type desktop implementation apparatus to perform a card-type desktop implementation method, the method comprising:
receiving a resource address of a service card from a server terminal;
creating a view area on a desktop, the view area being used to display the service card corresponding to the resource address;
creating a view corresponding to the service card in the view area;
acquiring a resource file corresponding to the resource address from the server terminal; and
rendering the resource file to the view according to information of the view.
